(19) United States
(12) Patent Application Publication
(10) Pub. No.: US 2024/0378565 A1
(43) Pub. Date: Nov. 14, 2024

(54) METHOD AND SYSTEM FOR INPUTTING AND OUTPUTTING SCHEDULE BASED ON NUMBER STRING FOR SCHEDULE MANAGEMENT

(71) Applicant: Dongha HWANG, Seoul (KR)

(72) Inventor: Dongha HWANG, Seoul (KR)

(21) Appl. No.: 18/782,673

(22) Filed: Jul. 24, 2024

Related U.S. Application Data
(63) Continuation of application No. PCT/KR2022/017381, filed on Nov. 10, 2022.

(30) Foreign Application Priority Data
Jan. 28, 2022 (KR) 10-2022-0012912

(51) Int. Cl. G06Q 10/1091

(52) U.S. Cl. CPC G06Q 10/1091

(57) ABSTRACT

Disclosed is a method for inputting and outputting a schedule performed by a terminal device. The method may include receiving an input of a first number string of one digit or more and a first schedule corresponding to the first number string; determining whether the first number string is distinguished into two number strings and whether the number of digits of the main number string among the first number string is 8 or less; based on at least one of whether the first number string is distinguished into two number strings or whether the number of digits of the main number string is 8 or less, converting the first number string to a first date according to the number of digits of the first number string; and generating a schedule content based on the first date and the first schedule.

### CROSS-REFERENCE TO RELATED APPLICATIONS

The present application is a continuation of International Patent Application No. PCT/KR2022/017381, filed on Nov. 10, 2022, which is based upon and claims the benefit of priority to Korean Patent Application No. 10-2022-0012912 filed on Jan. 28, 2022. The disclosures of the above-listed applications are hereby incorporated by reference herein in their entirety.

### BACKGROUND

### 1. Technical Field

The present disclosure relates to a schedule input and output method. More particularly, the present disclosure relates to a method for inputting and outputting a schedule based on a number string for schedule management and a system therefor.

### 2. Description of Related Art

As information and communication technology develops, many users access websites or applications through various terminal devices (e.g., PC or mobile) to exchange various information or to use SNS (social network service) services.

In addition, many users use websites or applications that can manage schedules through terminal devices. When entering a schedule (e.g., date and time for performing a specific task) through a terminal device, various methods can be used. However, no matter what method is currently used, there is a problem in entering dates for schedule management and it also takes a lot of time.

Particularly, the above problems are aggravated for users who work in occupations related to reservation work or who are in charge of work in which schedule preparation is essential.

### SUMMARY

The present disclosure is to provide a method for inputting and outputting a schedule based on a number string for schedule management and a system therefor.

The problems to be solved by the present disclosure are not limited to the problems mentioned above, and other problems not mentioned can be clearly understood by those skilled in the art from the description below.

In an aspect of the present disclosure, a method for inputting and outputting a schedule by a terminal device according to an embodiment may include receiving an input of a first number string of one digit or more and a first schedule corresponding to the first number string; determining whether the first number string is distinguished into two number strings and whether the number of digits of the main number string among the first number string is 8 or less; based on at least one of whether the first number string is distinguished into two number strings or whether the number of digits of the main number string is 8 or less, converting the first number string to a first date according to the number of digits of the first number string; and generating a schedule content based on the first date and the first schedule.

In addition, whether the first number string is distinguished into two number strings may be determined based on whether a blank space is included in the first number string, based on an inclusion of the blank space in the first number string, the number string at a left of the blank space is distinguished as a major number string, and the number string at a right of the blank space may be distinguished as a minor number string, and based on a blank space being not included in the first number string, the first number string may be identified as the main number string.

In addition, converting the first number string may include first to eighth steps according to the number of digits of the main number string among the first number string, and the first step in converting the first number string may include: based on determining that the number of digits in the main number string is 1, which is a value of 8 or less, converting the main number string to the first data by adding the date corresponding to the first number string to a date corresponding to a current date.

In addition, the second step in converting the first number string may include: based on the determination that the number of digits in the input main number string (AB) is 2, which is a value of 8 or less, based on the AB being a number string of 24 or less, converting the main number string to AB time, which is a time of the current date, based on the AB being a number string exceeding 24 and B is not 0, converting the main number string to the first date, which is the year corresponding to the current date, the month A, and the day B, and based on the AB being a number string exceeding 24 and the B is 0, converting the main number string to the first date, which is the year corresponding to the current date, the month A, and a last day of the month A.

In addition, the third step in converting the first number string may include: based on the determination that the number of digits in the input main number string (DEF) is 3, which is a value of 8 or less, based on the D being not 0, converting the main number string to the first date, which is the year corresponding to the current date, the D month, and the EF day, based on the D being 0, converting the main number string to the first date, which is the year corresponding to the current date, December, and the EF day, and based on the EF being a number string corresponding to the D month or a date not in the December, the EF is converted to the D month or the last day of the December.

In addition, the fourth step in converting the first number string may include: based on the determination that the number of digits in the input main number string (GHIJ) is 4, which is a value of 8 or less: based on the GHIJ being 0000 to 0099, converting the main number string to the first date, which is the year corresponding to the current date, December, and the IJ day, based on the GHIJ being 0100 to 1299, converting the main number string to the first date, which is the year corresponding to the current date, the GH month, and the IJ day, based on the IJ being a number string corresponding to the December or a date that is not in the GH month, the IJ is converted to a last day of the December or the GH month, based on the GHIJ being a second number string obtained by adding 10 to 2000 to the year corresponding to the current date, converting the main number string to the first date, which is December 31, year GHIJ, and based on the GHIJ being 1300 to 9999 and the main number string being not the second number string, converting the main number string to the first date based on the year corresponding to the current date plus the G and the date of applying the third step to the HIJ.

In addition, the fifth step in converting the first number string may include: based on the determination that the number of digits of the input main number string (KLMNO) is 5, which is 8 or less, converting the main number string to the first date based on the year corresponding to the current date plus the K and the date of applying the fourth step to the LMNO, and based on the LMNO being a number string between 1300 and 9999, the fourth step is applied by identifying L to 0, the sixth step in converting the first number string may include: based on the determination that the number of digits of the input main number string (PQRSTU) is 6, which is 8 or less, converting the main number string to the first date based on year 20PQ and the date of applying the fourth step to the RSTU, and based on the RSTU being a number string between 1300 and 9999, the fourth step is applied by identifying R to 0, the seventh step in converting the first number string may include: based on determining that the number of digits of the input main number string (VWXYZab) is 7, converting the main number string to the first date based on the date of applying the eighth step to the 2VWXYZab, and the eighth step in converting the first number string may include: based on the determination that the number of digits in the input main number string (defghijk) is 8, converting the main number string to the first date based on year defg and the date of applying the fourth step to the hijk, and based on the hijk being a number string between 1300 and 9999, the fourth step is applied by identifying h to 0.

In addition, converting the first number string may include: ignoring the minor number string based on the main number string being 00 to 24, and converting the first date based on the time corresponding to the minor number string, based on the main number string being not a number string between 00 and 24.

In another aspect of the present disclosure, a computer program stored in a computer-readable recording medium may be disclosed to perform the method of inputting and outputting a schedule of any one of claims 1 to 8, which is combined with a terminal device that is hardware.

In still another aspect of the present disclosure, a terminal device for providing a method for inputting and outputting a schedule according to another embodiment may include a memory configured to store one or more instructions; and one or more processors, wherein the one or more processors is/are configured to: receive an input of a first number string of one digit or more and a first schedule corresponding to the number string; determine whether the number of digits of the input number string is 8 or less; determine whether the first number string is distinguished into two number strings; based on at least one of whether the number of digits of the input first number string is 8 or less or whether the input first number string is distinguished into two number strings, convert the first number string to a first date according to the number of digits of the first number string; and generate a schedule content based on the first date and the first schedule.

In addition, a computer-readable recording medium recording a computer program for executing a method for implementing the present disclosure may be further provided.

### BRIEF DESCRIPTION OF THE FIGURES

FIG. 1 is a schematic diagram of a system for implementing a method for inputting and outputting a schedule based on a number string according to an embodiment of the present disclosure.

FIG. 2 is a flowchart for describing a method of inputting and outputting a schedule based on a number string according to an embodiment of the present disclosure.

FIGS. 3, 4A, and 4B are diagrams for describing converting a date based on a number string according to an embodiment of the present disclosure.

FIG. 5 is a flowchart for describing converting a date based on a number string according to an embodiment of the present disclosure.

FIG. 6 is a block diagram for describing the configuration of a terminal device according to an embodiment of the present disclosure.

### DETAILED DESCRIPTION

The advantages and features of the present disclosure, and methods for achieving them, will become clear with reference to the embodiments described in detail below along with the accompanying drawings. However, the present disclosure is not limited to the embodiments disclosed below and may be implemented in various different forms. The present embodiments are merely provided to ensure that the present disclosure is complete, and provided to fully convey the scope of the present disclosure to those skilled in the art to which the present disclosure pertains. The present disclosure is defined only by the scope of the claims.

The terminology used herein is for the purpose of describing embodiments and is not intended to limit the disclosure. As used herein, singular forms also include plural forms, unless specifically stated otherwise in the context. As used in the specification, “comprises” and/or “comprising” does not exclude the presence or addition of one or more other elements in addition to the mentioned elements.

The same reference numerals refer to the same elements throughout the specification, and “and/or” includes each and every combination of one or more of the referenced elements. Although “first”, “second”, and the like are used to describe various components, these components are of course not limited by these terms.

These terms are merely used to distinguish one component from another. Therefore, the first component mentioned below may also be the second component within the technical spirit of the present disclosure.

Unless otherwise defined, all terms (including technical and scientific terms) used in this specification may be used with meanings commonly understood by those skilled in the art to which this disclosure pertains. Additionally, terms defined in commonly used dictionaries are not to be interpreted ideally or excessively unless clearly specifically defined.

Spatially relative terms such as “below”, “beneath”, “lower”, “above”, “upper”, and the like, as shown in the drawings, may be used to easily describe the correlation between one component and other components. Spatially relative terms should be understood as terms that include different directions of components during use or operation in addition to the directions shown in the drawings.

For example, when a component shown in a drawing is turned over, a component described as “below” or “beneath” one component may be placed “above” the other component. Accordingly, the exemplary term “down” may include both downward and upward directions. A component may also be oriented in other direction, so spatially relative terms may be interpreted according to orientation.

Hereinafter, the embodiments of the present disclosure will be described in detail with reference to the attached drawings.

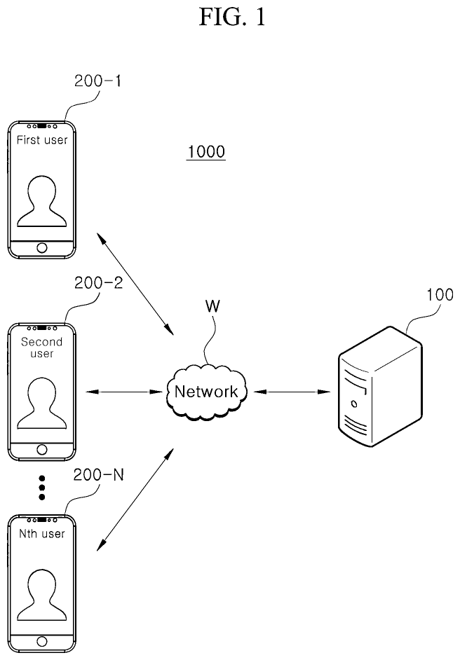

FIG. 1 is a schematic diagram of a system 1000 for implementing a method for inputting and outputting a schedule based on a number string according to an embodiment of the present disclosure.

As shown in FIG. 1, the system 1000 may include a server 100 and terminal devices 200-1, 200-2, . . . 200-N used by a plurality of users. Although not shown in FIG. 1, the system 1000 may additionally include a device for managing the server 100.

FIG. 1 shows a case where terminal devices 200-1, 200-2, . . . 200-N used by a plurality of users are implemented as smartphones, but this is merely an embodiment. Each of the terminal devices 200-1, 200-2, . . . 200-N may be implemented as various types of electronic devices such as a smartphone, a desktop PC, a tablet PC, a laptop, a medical device, and a wearable device.

Each device included in the system 1000 may perform communication through a network W. Here, the network W may include a wired network and a wireless network. For example, the network may include various networks such as a local area network (LAN), a metropolitan area network (MAN), and a wide area network (WAN).

Additionally, the network may include the known World Wide Web (WWW). However, the network according to the embodiment of the present disclosure is not limited to the networks listed above, and may include at least some of a known wireless data network, a known telephone network, and a known wired and wireless television network.

The terminal devices 200-1, 200-2, . . . 200-N used by a plurality of users use the ‘schedule input/output service based on a number string for schedule management’ provided through the server 100 and perform a schedule management.

The ‘schedule input/output service based on a number string for schedule management’ refers to a service that coverts a date corresponding to the number string based on an input number of digits of the number string or a presence of distinguishment of the number string (e.g., main number string or minor number string).

Through the above service, a user may enter/select a specific date by entering only a simplified number without having to enter all of the specific dates (e.g., year/month/day) or directly select the specific date from a calendar icon. Accordingly, the user may be provided with a quick/simplified date input service. The Embodiments of the above service will be described in detail with reference to the section described below.

The server 100 may provide data for using the ‘schedule input/output service based on a number string for schedule management’ to the terminal devices 200-1, 200-2, . . . 200-N used by a plurality of users.

For example, the server may provide the data (e.g., URL (uniform resource locator), etc.) that enables to install a program (or application) for using the schedule input/output service based on a number string for schedule management to the terminal devices 200-1, 200-2, . . . 200-N used by a plurality of users.

As another example, the server may provide the data that enables to use the schedule input/output service based on a number string for schedule management to the terminal devices 200-1, 200-2, . . . 200-N used by a plurality of users.

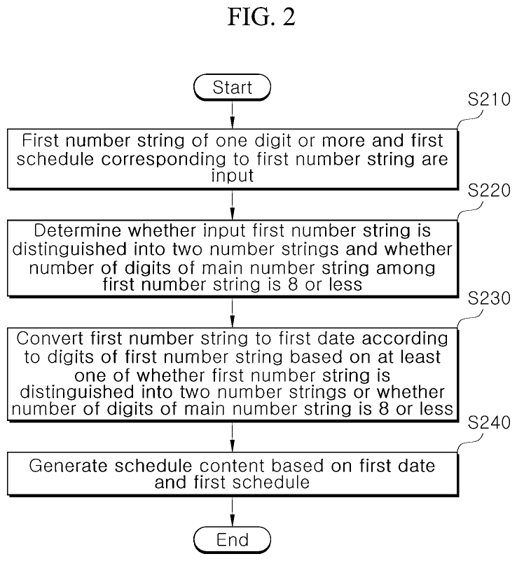

FIG. 2 is a flowchart for describing a method of inputting and outputting a schedule based on a number string according to an embodiment of the present disclosure. That is, FIG. 2 is a flowchart for describing a method for a terminal device to utilize the service in the case that the terminal device is provided with the schedule input/output service based on a number string for schedule management.

Before a separate number string (i.e., a separate number for year/month/day input) is input, the terminal device may recognize year/month/day as a date of a default value. Additionally, before a separate number is input related to a time, the terminal device may recognize a time (e.g., 0 o'clock or 24 o'clock) as a default value.

The terminal device may obtain a first number string of one digit or more and a first schedule corresponding to the first number string from the user (step S210). Here, the first schedule corresponding to the first number string means a schedule that may be matched to the first date that may be converted based on the first number string.

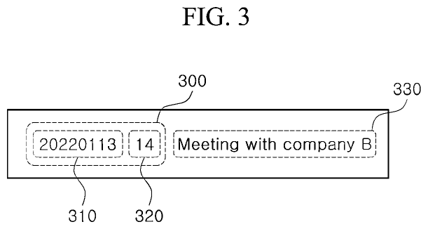

For example, referring to FIG. 3, the terminal device may receive an input of the first number string of one digit or more (e.g., ‘20220113 14’) 300 and a first schedule (e.g., meeting with company B) 330 corresponding to the first number string 300 from the user. That is, FIG. 3 is a diagram illustrating an embodiment in which the user inputs a meeting schedule by matching a specific date that may be converted based on ‘20220113 14’ to the meeting schedule.

The terminal device may determine whether the input first number string is distinguished into two number strings and whether the number of digits of the main number string among the first number string is 8 or less (step S220).

In one embodiment of the present disclosure, the terminal device may determine whether the first number string is distinguished into two number strings (that is, a main number string and a minor number string). For example, the terminal device may determine whether the first number string is distinguished from two number strings based on whether a blank space is included in the first number string.

Based on the inclusion of a blank space in the first number string, the terminal device may distinguish the number string at a left of the blank space as a main number string, and the number string at a right of the blank space as a minor number string. In the case that a blank space is not included in the first number string, the terminal device may identify the first number string as the main number string.

In another embodiment of the present disclosure, the terminal device may determine whether the number of digits of the main number string in the first number string is 8 or less. At this time, in the case that the first number string does not include a minor number string (i.e., the user does not enter the minor number string after entering the main number string) or in the case that the main number string is 00 to 24, the terminal device may ignore the minor number string and may determine whether the number of digits in the first number string (i.e., the main number string) is 8 or less.

The terminal device may convert the first number string to a first date according to a digit of the first number string based on at least one of whether the first number string is distinguished into two number strings or whether the number of digits of the main number string is 8 or less (step S230).

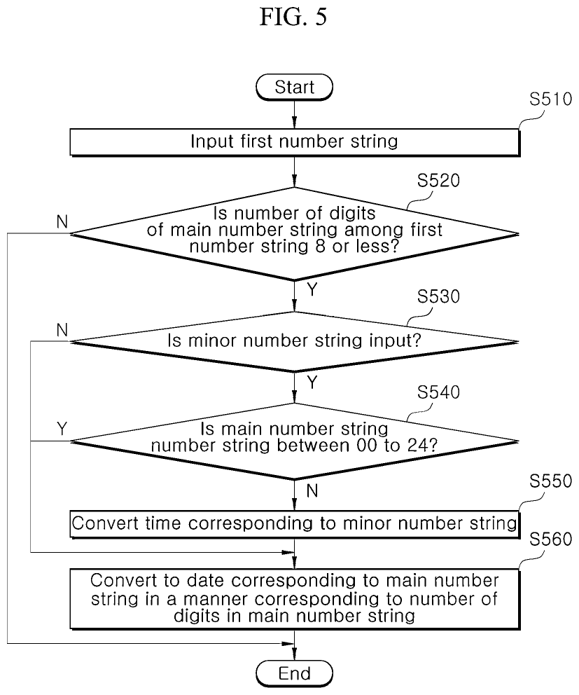

Specifically, when the number of digits in the main number string is 8 or less, the terminal device may convert the main number string into a date using a matching method for each digit of the main number string. The matching method for each digit of the main number string will be described in detail with reference to FIG. 5.

When the minor number string exists separately (that is, when the first number string is divided into two number strings), the terminal device may convert the minor number string to a specific time. Additionally, the terminal device may convert the first number string into the first date based on the date converted from the main number string and the time converted from the minor number string.

Thereafter, the terminal device may generate a schedule content based on the first date and the first schedule (step S240). Specifically, the terminal device may input/store the schedule content matching the first date and the first schedule in a separate database, an application installed on the terminal device, or a separate UI.

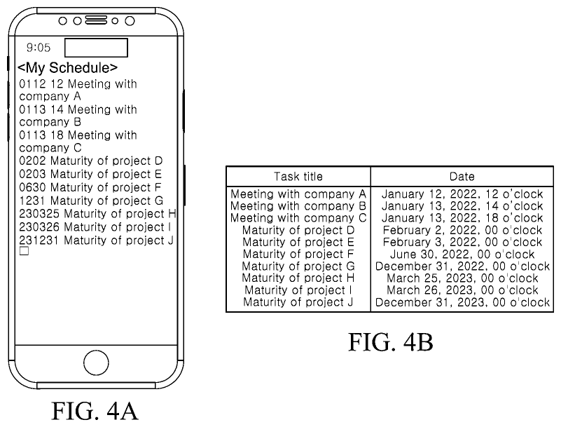

For example, as shown in FIG. 4A, the terminal device may receive an input of a plurality of number strings and a schedule corresponding to the plurality of number strings from the user. The terminal device may convert multiple input number strings into specific date. The number string and the schedule corresponding to the number string may be entered in sentence units. In other words, when ‘0112 12 meeting with company A’ is entered and a key to change a line (e.g., an enter key) is input, the terminal device may convert it to the schedule content corresponding to ‘0112 12 meeting with company A’.

As shown in FIG. 4B, the terminal device may configure and store the converted specific date and the corresponding schedule content in a separate database.

FIG. 5 is a flowchart for describing converting a date based on a number string according to an embodiment of the present disclosure.

An electronic device may receive a first number string as input (step S510). Step S510 in FIG. 5 may correspond to step S210 in FIG. 2.

The terminal device may identify whether the number of digits of the main number string among the first number string is 8 or less (step S520). Here, when the minor number string is not input, the main number string and the first number string may be synonyms.

In the case that the number of digits of the main number string among the first number string is more than 8, the terminal device may not apply a specific algorithm to the first number string.

In the case that the number of digits of the main number string among the first number string is 8 or less, the terminal device may determine whether a minor number string is input (step S530).

Specifically, the terminal device may determine whether a number string (i.e., main number string) and a space (i.e., space bar input) are input, and a separate number string (i.e., minor number string) is input.

In the case that it is determined that the minor number string is input, the terminal device may determine whether the main number string is a number string between 00 to 24 among the two-digit number strings (step S540).

In the case that the minor number string is input and the main number string is not 00 to 24, the terminal device may convert to the time corresponding to the minor number string (step S550).

For example, in the case that the minor number string is input as ‘15’, the terminal device may convert the minor number string to ‘15 o'clock’. At this time, both ‘minute’ and ‘second’ units may be unified as 0 minute and 0 second, but this may be changed.

In the case that the minor number string is not entered, or even in the case that the minor number string is entered, the main number string is 00 to 24, the terminal device (ignoring the minor number string) may convert to a date corresponding to the main number string in a manner corresponding to the number of digits in the main number string (step S560).

In addition, after converting the time corresponding to the minor number string, the terminal device may convert the main number string into the corresponding date in a manner that corresponds to the number of digits of the main number string (step S560).

The method (or step) of converting the main number string to a date in a manner that corresponds to the number of digits in the main number string is as follows.

In one embodiment of the present disclosure, based on the number of digits in the first number string being 1, the terminal device may convert the main number string to a first date by adding a date corresponding to the first number string to the date corresponding to a current date.

For example, in the case that the main number string is ‘2’ and the current date is ‘Jan. 16, 2022’, the terminal device may convert the main number string to the date called ‘Jan. 18, 2022 (i.e., the date corresponding to the current date plus 2)’.

For example, in the case that the main number string is ‘5’ and the current date is ‘Jan. 16, 2022’, the terminal device may convert the main number string to ‘Jan. 21, 2022 (i.e., the date corresponds to the current date plus 5)’.

As another embodiment of the present disclosure, it is assumed that the number of digits in the first number string (AB) is 2. Based on the AB is a number string of 24 or less, the terminal device may convert the main number string to AB time, which is the time of the current date. That is, when the number string is a two-digit number string from 00 to 24, the terminal device may, as an exception, visually recognize the main number string.

For example, when the main number string is ‘14’ and the current date is ‘Jan. 16, 2022’, the terminal device may convert the main number string to the date ‘Jan. 16, 2022, and 14 o'clock’.

And, when the AB is a number string exceeding 24 and B is not 0, the terminal device may convert the main number string to the first date, which is the year corresponding to the current date, the month A, and the day B.

For example, when the main number string is ‘26’ and the current date is ‘Jan. 16, 2022’, the terminal device may convert the main number string to the date ‘Feb. 6, 2022’.

In the case that the AB is greater than 24 and B is 0, the terminal device may convert the main number string into the first date, which is the year corresponding to the current date, the month A, and the last day of the month A.

For example, in the case that the main number string is ‘30’ and the current date is ‘Jan. 16, 2022’, the terminal device may convert the main number string to the date ‘Mar. 31, 2022 (i.e., the last day of March)’.

As another embodiment of the present disclosure, it is assumed that the number of digits in the main number string (DEF) is 3, which is 8 or less. In the case the D is not 0, the terminal device may convert the main number string to the first date, which is the year, the D month, and the EF day corresponding to the current date.

For example, in the case that the main number string is ‘112’ and the current date is ‘Jan. 16, 2022’, the terminal device may convert the main number string to the date ‘Jan. 12, 2022’.

In the case that D is 0, the terminal device may convert the main number string to the first date, which is the year, December, and the EF day corresponding to the current date.

For example, in the case that the main number string is ‘029’ and the current date is ‘Jan. 16, 2022’, the terminal device may convert the main number string to the date ‘Dec. 29, 2022’.

At this time, in the case that the EF is a number string corresponding to a date not in month D or December, the EF may be converted to the last day or 31st day of the month D. For example, when the main number string is ‘033’, in the case that the main number string is converted to December 33, the 33^{rd} day is a non-existent date. Therefore, the terminal device may convert the EF to 31, the last day of December.

As another embodiment of the present disclosure, it is assumed that the number of digits in the main number string (GHIJ) is 4.

When GH is 00, the terminal device may convert the main number string to the first date, which is the year, December, and the IJ day corresponding to the current date.

For example, in the case that the main number string is ‘0029’ and the current date is ‘Jan. 16, 2022’, the terminal device may convert the main number string to the date ‘Dec. 29, 2022’.

When GH is 01 to 12, the terminal device may convert the main number string to the first date, which is the year corresponding to the current date, the GH month, and the IJ day.

For example, in the case that the main number string is ‘1129’ and the current date is ‘Jan. 16, 2022’, the terminal device may convert the main number string to the date ‘Nov. 29, 2022’.

When GHIJ is a second number string obtained by adding 10 to the year corresponding to 2000 or the current date, the terminal device may convert the main number string to the first date, which is December 31 of the GHIJ year.

For example, in the case that the main number string is ‘2031’ and the current date is ‘Jan. 16, 2022’, the terminal device may convert the main number string to the date ‘Dec. 31, 2031’.

When GH is 13 to 99 and is not the second number string, the terminal device may convert the main number string to the first date based on the year corresponding to the current date plus G, and the date of applying the third step (or method) to the HIJ. Here, the third step refers to the step (or method) applied when the number of digits in the number string is 3.

For example, in the case that the main number string is ‘1302’ and the current date is ‘Jan. 16, 2022’, the terminal device may convert the main number string to ‘Mar. 2, 2023 (i.e., the year 2022 corresponding to the current date added by 1)’.

As another embodiment of the present disclosure, it is assumed that the number of digits in the main number string (KLMNO) is 5.

The terminal device may convert the main number string into the first date based on the year corresponding to the current date plus the K value, and the date of applying the fourth step to the LMNO, and in the case that the LMNO is a number string between 1300 and 9999, the main number string may be converted to the first date by applying the fourth step after the L may be identified as 0.

For example, in the case that the main number string is ‘01209’ and the current date is ‘Jan. 16, 2022’, the terminal device may convert the main number string to the date ‘Dec. 9, 2022 (i.e., the year 2022 corresponding to the current date added by 0)’.

As another example, in the case that the main number string is ‘11111’ and the current date is ‘Jan. 16, 2022’, the terminal device may convert the main number string to the date ‘Nov. 11, 2023’.

As another embodiment of the present disclosure, it is assumed that the number of digits in the main number string (PQRSTU) is 6.

The terminal device may convert the main number string to the first date based on the 20PQ year and the date of applying the fourth step to the RSTU, but when the RSTU is a number string between 1300 and 9999, the main number string may be converted to the first date by applying the fourth step after the R is identified as 0.

For example, in the case that the main number string is ‘001209’ and the current date is ‘Jan. 16, 2022’, the terminal device may convert the main number string to the date ‘Dec. 9, 2000’.

As another example, in the case that the main number string is ‘111111’ and the current date is ‘Jan. 16, 2022’, the terminal device may convert the main number string to the date ‘Nov. 11, 2011’.

As another embodiment of the present disclosure, it is assumed that the number of digits in the main number string (defghijk) is 8. The terminal device may convert the main number string to the first date based on the year defg and the date of applying the fourth step to the hijk, but when the hijk is a number string between 1300 and 9999, the main number string may be converted to the first date by applying the fourth step after the h is identified as 0.

For example, in the case that the main number string is ‘20211209’ and the current date is ‘Jan. 16, 2022’, the terminal device may convert the main number string to the date ‘Dec. 9, 2021’.

As another example, in the case that the main number string is ‘20211302’ and the current date is ‘Jan. 16, 2022’, the terminal device may convert the main number string to the date ‘Mar. 2, 2021 (i.e., h is identified as 0)’.

As another embodiment of the present disclosure, it is assumed that the number of digits in the main number string (VWXYZab) is 7. The terminal device may convert the main number string into the first date based on the date of applying the eighth method (or step) to the 2VWXYZab. That is, the terminal device may add 2 in front of the main number string and then convert it to the date by applying the eighth method (i.e., the method applied when the main number string is 8) to the number.

For example, in the case that the main number string is ‘0211209’ and the current date is ‘Jan. 16, 2022’, the terminal device may convert the main number string to the date ‘Dec. 9, 2021’ based on the number of the main number string (i.e., 20211209) added by 2.

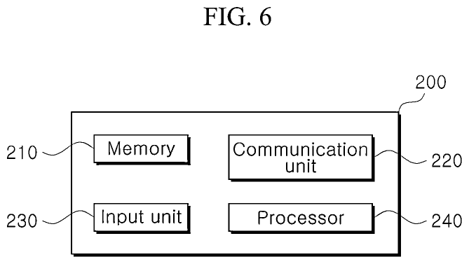

FIG. 6 is a block diagram for describing the configuration of a terminal device according to an embodiment of the present disclosure.

As shown in FIG. 6, the terminal device 200 may include a memory 210, a communication unit 220, an input unit 230, and a processor 240, but not limited thereto, and a software and hardware configuration of the terminal device may be modified or added according to the required operation within the scope obvious to those skilled in the art.

The memory 210 may store one or more instructions for executing various operations. The memory 210 may store data for executing a method of inputting and outputting the schedule based on the number string provided from a server. Additionally, the memory 210 may store the schedule content generated based on the date converted based on the number string and the schedule corresponding to the date.

The communication unit 220 may perform communication with an external device and may include one or more wireless communication modules or wired communication modules for performing communication. The communication unit 220 may exchange data or signals with the server 100 or the terminal device 200 for managing the server 100.

The input unit 230 may include a module that may receive various commands from a user. For example, the input unit 230 may be implemented as a keyboard, a button, a touch panel, and the like, but is not limited thereto. The input unit 130 may receive various commands from the user (for example, touching a specific button to input a number string, etc.).

The processor 240 may be electrically connected to the memory 210 and may control the overall operation and functions of the terminal device 200. The overall operations and functions of the terminal device 200 described with reference to FIGS. 2 to 5 may be implemented by the processor 240.

The steps of the method or algorithm described in connection with the embodiments of the present disclosure may be implemented directly in hardware, implemented as a software module executed by hardware, or a combination thereof. The software module may reside on RAM (Random Access Memory), ROM (Read Only Memory), EPROM (Erasable Programmable ROM), EEPROM (Electrically Erasable Programmable ROM), Flash Memory, hard disk, removable disk, CD-ROM, or any type of computer-readable recording medium well known in the art to which the present disclosure pertains.

As described above, embodiments of the present disclosure have been described with reference to the attached drawings, but it is understood that those skilled in the art will understand that the present disclosure may be implemented in other specific forms without changing its technical idea or essential features. Therefore, the embodiments described above should be understood in all respects as illustrative and not restrictive.

According to the present disclosure, a method for inputting and outputting a schedule based on a number string for schedule management and a system therefor may be provided.

In addition, according to the present disclosure, a method of quickly and accurately entering a schedule by simply entering a number string without a pop-up window in the form of a calendar may be provided.

In addition, according to the present disclosure, an efficient schedule input means may be provided for people working in various reservations such as airline accommodations or for users of a to-do list program who frequently input dates on a mobile terminal with an inconvenient input keyboard.

The effects of the present disclosure are not limited to the effects mentioned above, and other effects not mentioned may be clearly understood by those skilled in the art from the description.

What is claimed is:

1. A method for inputting and outputting a schedule by a terminal device, the method comprising:
receiving an input of a first number string of one digit or more and a first schedule corresponding to the first number string;
determining whether the first number string is distinguished into two number strings and whether the number of digits of the main number string among the first number string is 8 or less;
based on at least one of whether the first number string is distinguished into two number strings or whether the number of digits of the main number string is 8 or less, converting the first number string to a first date according to the number of digits of the first number string; and
generating a schedule content based on the first date and the first schedule.

2. The method of claim 1, wherein,
whether the first number string is distinguished into two number strings is determined based on whether a blank space is included in the first number string,
based on an inclusion of the blank space in the first number string, the number string at a left of the blank space is distinguished as a main number string, and the number string at a right of the blank space is distinguished as a minor number string, and
based on a blank space being not included in the first number string, the first number string is identified as the main number string.

3. The method of claim 2, wherein,
converting the first number string includes first to eighth steps according to the number of digits of the main number string among the first number string, and
the first step in converting the first number string includes:
based on determining that the number of digits in the main number string is 1, which is a value of 8 or less, converting the main number string to the first data by adding the date corresponding to the first number string to a date corresponding to a current date.

4. The method of claim 3, wherein,
the second step in converting the first number string includes:
based on the determination that the number of digits in the input main number string (AB) is 2, which is a value of 8 or less,
based on the AB being a number string of 24 or less, converting the main number string to AB time, which is a time of the current date,
based on the AB being a number string exceeding 24 and B is not 0, converting the main number string to the first date, which is the year corresponding to the current date, the month A, and the day B, and
based on the AB being a number string exceeding 24 and the B is 0, converting the main number string to the first date, which is the year corresponding to the current date, the month A, and a last day of the month A.

5. The method of claim 4, wherein,
the third step in converting the first number string includes:
based on the determination that the number of digits in the input main number string (DEF) is 3, which is a value of 8 or less,
based on the D being not 0, converting the main number string to the first date, which is the year corresponding to the current date, the D month, and the EF day,
based on the D being 0, converting the main number string to the first date, which is the year corresponding to the current date, December, and the EF day, and
based on the EF being a number string corresponding to the D month or a date not in the December, the EF is converted to the D month or the last day of the December.

6. The method of claim 3, wherein,
the fourth step in converting the first number string includes:
based on the determination that the number of digits in the input main number string (GHIJ) is 4, which is a value of 8 or less:
based on the GHIJ being 0000 to 0099, converting the main number string to the first date, which is the year corresponding to the current date, December, and the IJ day,
based on the GHIJ being 0100 to 1299, converting the main number string to the first date, which is the year corresponding to the current date, the GH month, and the IJ day,
based on the IJ being a number string corresponding to the December or a date that is not in the GH month, the IJ is converted to a last day of the December or the GH month,
based on the GHIJ being a second number string obtained by adding 10 to 2000 to the year corresponding to the current date, converting the main number string to the first date, which is December 31, year GHIJ, and
based on the GHIJ being 1300 to 9999 and the main number string being not the second number string, converting the main number string to the first date based on the year corresponding to the current date plus the G and the date of applying the third step to the HIJ.

7. The method of claim 6, wherein,
the fifth step in converting the first number string includes:
based on the determination that the number of digits of the input main number string (KLMNO) is 5, which is 8 or less, converting the main number string to the first date based on the year corresponding to the current date plus the K and the date of applying the fourth step to the LMNO, and based on the LMNO being a number string between 1300 and 9999, the fourth step is applied by identifying L to 0,
the sixth step in converting the first number string includes:
based on the determination that the number of digits of the input main number string (PQRSTU) is 6, which is 8 or less, converting the main number string to the first date based on year 20PQ and the date of applying the fourth step to the RSTU, and based on the RSTU being a number string between 1300 and 9999, the fourth step is applied by identifying R to 0,
the seventh step in converting the first number string includes:
based on determining that the number of digits of the input main number string (VWXYZab) is 7, converting the main number string to the first date based on the date of applying the eighth step to the 2VWXYZab, and
the eighth step in converting the first number string includes:
based on the determination that the number of digits in the input main number string (defghijk) is 8, converting the main number string to the first date based on year defg and the date of applying the fourth step to the hijk, and based on the hijk being a number string between 1300 and 9999, the fourth step is applied by identifying h to 0.

8. The method of claim 2, wherein,
converting the first number string includes:
ignoring the minor number string based on the main number string being 00 to 24, and
converting the first date based on the time corresponding to the minor number string, based on the main number string being not a number string between 00 and 24.

9. A computer program stored in a computer-readable recording medium to perform the method of inputting and outputting a schedule of claim 1, which is combined with a terminal device that is hardware.

10. A terminal device for providing a method for inputting and outputting a schedule, comprising:
a memory configured to store one or more instructions; and
one or more processors,
wherein the one or more processors is/are configured to:
receive an input of a first number string of one digit or more and a first schedule corresponding to the number string;
determine whether the number of digits of the input number string is 8 or less;
determine whether the first number string is distinguished into two number strings;
based on at least one of whether the number of digits of the input first number string is 8 or less or whether the input first number string is distinguished into two number strings, convert the first number string to a first date according to the number of digits of the first number string; and
generate a schedule content based on the first date and the first schedule.
